(19) United States
(12) Patent Application Publication
(10) Pub. No.: US 2009/0033799 A1
(43) Pub. Date: Feb. 5, 2009

(54) VIDEO PROCESSING METHOD AND VIDEO PROCESSING APPARATUS USING THE SAME

(75) Inventor: Kyoung-hwan KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/015,098

(22) Filed: Jan. 16, 2008

(30) Foreign Application Priority Data
Aug. 2, 2007 (KR) 10-2007-0077735

(51) Int. Cl. H04N 9/78; H04N 9/77

(52) U.S. Cl. 348/665; 348/663; 348/E09.035; 348/E09.036

(57) ABSTRACT

A video processing method and a video processing apparatus employing the same are provided. The video processing apparatus measures an amount of noise included in an incoming composite video signal, and outputs 2D comb filtered signal and 3D comb filtered signal in different proportions according to the measured amount of noise. By varying the proportions of the 2D comb filtered signal and 3D comb filtered signal according to the measured amount of noise, video artifacts associated with 2D and 3D comb filtering are compensated and improved.

### CROSS-REFERENCE TO RELATED APPLICATION

This application claims priority from Korean Patent Application No. 2007-0077735, filed Aug. 2, 2007 in the Korean Intellectual Property Office, the entire disclosure of which is hereby incorporated by reference.

### BACKGROUND OF THE INVENTION

1. Field of the Invention

Methods and apparatuses consistent with the present invention relate to video processing, and more particularly, to a video processing method for separating a luminance signal and a chroma signal from an incoming composite video signal, and a video processing apparatus applying the same.

2. Description of the Related Art

A composite video signal generally contains a luminance signal and a chroma signal. A video processing apparatus separates a luminance signal and a chroma signal from an incoming composite signal, and processes the separated signals respectively.

Specifically, a video processing apparatus processes an incoming composite video signal to improve video quality, by separating a luminance signal and a chroma signal using a comb filter, that is, by using a 2D comb filter to process the incoming composite video signal if detecting relatively large motion, and using a 3D comb filter to process the video signal if detecting relatively small motion.

A 2D comb filter adds or subtracts a previous line to or from a current line, using a line delay in one frame, to separate luminance and chroma signals. A 3D comb filter, or temporal comb filter, adds or subtracts current and previous frames using inter-frame time delay to separate luminance and chroma signals.

When an incoming composite video signal contains noise, a related art video processing apparatus would have an artifact in a video because the apparatus fails to consider the noise.

Specifically, the presence of noise in a composite video signal affects the process of detecting motions, which results in inability to detect the actual motion contained in the composite video signal.

As a result, a video processing apparatus misrecognizes even a slight noise in a composite video signal as a motion, and so uses a 2D comb filter, causing an artifact to occur due to inappropriate use of 2D comb filtering.

Video artifacts due to 2D comb filtering include handling dots, a dot crawl, or a cross color which flickers usually in a boundary or detailed area.

A 3D comb filter may cause mesh error appearing as a meshed net on a video, as it is used to filter a noise-laden composite video signal.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a video processing method for filtering a composite video signal in consideration of the amount of noise contained in an incoming composite video signal, and a video processing apparatus applying the same.

The present invention also provides a video processing method for measuring an amount of noise contained in an incoming composite video signal and separating a luminance signal and a chroma signal from the composite video signal adaptively according to the measured amount of noise, and a video processing apparatus applying the same.

The present invention also provides a video processing method for enhancing video quality by increasing a 2D or 3D comb filtering according to the amount of noise measured from an incoming composite video signal, and a video processing apparatus applying the same.

According to an aspect of the present invention, there is provided a video processing method, including separating an incoming video signal into a luminance signal and a chroma signal using a first filtering and a second filtering, measuring a level of noise contained in the incoming video signal, and based on the measured level of noise, mixing luminance signals separated by the first and second filtering and outputting the result, and mixing chroma signals separated by the first and second filtering and outputting the result.

The outputting may include outputting the luminance signal separated by the first filtering and the luminance signal separated by the second filtering in different proportions according to the measured level of noise, and outputting the chroma signal separated by the first filtering and the chroma signal separated by the second filtering in different proportions according to the measured level of noise.

The measuring may include removing the chroma signal by low pass filtering the incoming video signal, performing integration of the luminance signal from which the chroma signal is removed, slicing the resultant luminance signal from the integration based on a predetermined slice level, detecting a sync region in the sliced luminance signal, and outputting a sync region signal that includes information about the detected sync region, and performing integration of the sync region of the incoming video signal based on the output sync region signal and outputting the result as a noise level.

The outputting may include outputting a noise gain corresponding to the luminance signal and the chroma signal according to the measured level of noise, and the noise gain is output according to the measured level of noise based on a noise gain determining value.

The noise gain determining value may include a threshold level as a reference to be compared with the measured level of noise, and a luminance gain and a chroma gain which determine a slope of the noise gain.

The outputting the noise gain may include outputting a negative noise gain corresponding to the luminance signal and the chroma signal if the measured level of noise is below the threshold level, and outputting a positive noise gain corresponding to the luminance signal and the chroma signal if the measured level of noise exceeds the threshold level.

The outputting may further include comparing the incoming video signal with a previously input video signal, and detecting a luminance motion signal that indicates the degree of motion of a luminance component, and a chroma motion signal that indicates the degree of motion of a chroma component of the incoming video signal.

The outputting may further include adding a noise gain corresponding to the luminance signal to the detected luminance motion signal, and adding a noise gain corresponding to the chroma signal to the detected chroma motion signal.

The first filtering may be a 2D comb filtering, and the second filtering may be a 3D comb filtering.

The incoming video signal may be a composite video signal.

According to another aspect of the present invention, there is provided a video processing apparatus, including a first filtering unit which separates an incoming video signal into a luminance signal and a chroma signal using a first filtering and a second filtering, a second filtering unit which separates the luminance signal and the chroma signal with respect to the incoming video signal, a noise measuring unit which measures a level of noise contained in the incoming video signal, and a mixer which mixes the luminance signals separated by the first and second filtering and outputs the result, and mixes the chroma signals separated by the first and second filtering and outputs the result, based on the measured level of noise.

The mixer may output the luminance signal separated by the first filtering and the luminance signal separated by the second filtering in different proportions according to the measured level of noise, and may output the chroma signal separated by the first filtering and the chroma signal separated by the second filtering in different proportions according to the measured level of noise.

The noise measuring unit may include a low pass filtering unit which removes the chroma signal by low pass filtering the incoming video signal, a first integrator which performs integration of the luminance signal from which the chroma signal is removed, a slicer which slices the resultant luminance signal from the first integrator based on a predetermined slice level, a sync detecting unit which detects a sync region in the sliced luminance signal, and outputs a sync region signal that includes information about the detected sync region, and a second integrator which performs integration of the sync region of the incoming video signal based on the output sync region signal and outputs the result as a noise level.

The video processing apparatus may further include a noise gain control unit which outputs a noise gain corresponding to the luminance signal and the chroma signal according to the measured level of noise, in which the noise gain control unit outputs the noise gain according to the measured level of noise based on a noise gain determining value.

The noise gain determining value may include a threshold level as a reference to be compared with the measured level of noise, and a luminance gain and a chroma gain which determine a slope of the noise gain.

The noise gain control unit may output a negative noise gain corresponding to the luminance signal and the chroma signal if the measured level of noise is below the threshold level, and may output a positive noise gain corresponding to the luminance signal and the chroma signal if the measured level of noise exceeds the threshold level.

The video processing apparatus may further include a motion detecting unit which compares the incoming video signal with a previously input video signal, and detects a luminance motion signal that indicates the degree of motion of a luminance component, and a chroma motion signal that indicates the degree of motion of a chroma component of the incoming video signal.

The video processing apparatus may further include a first adder which adds a noise gain corresponding to the luminance signal to the detected luminance motion signal, and a second adder which adds a noise gain corresponding to the chroma signal to the detected chroma motion signal.

The first filtering may be a 2D comb filtering, and the second filtering may be a 3D comb filtering.

The incoming video signal may be a composite video signal.

According to an aspect of the present invention, there is provided a video processing method, including separating an incoming video signal into first and second signals using a first filtering and a second filtering respectively, measuring a level of noise contained in the incoming video signal, based on the measured level of noise, mixing the first signals separated by the first and second filtering and outputting the result, and mixing the second signals separated by the first and second filtering and outputting the result.

According to an aspect of the present invention, there is provided a video processing apparatus, including a first filtering unit which separates an incoming video signal into a first signal and a second signal, a second filtering unit which separates the first signal and the second signal with respect to the incoming video signal, a noise measuring unit which measures a level of noise contained in the incoming video signal, and a mixer which mixes the first signals separated by the first and second filtering and outputs the result, and mixes the second signals separated by the first and second filtering and outputs the result, based on the measured level of noise.

### BRIEF DESCRIPTION OF THE DRAWINGS

The above and other aspects of the present invention will be more apparent from the following detailed description of exemplary embodiments with reference to the accompanying drawings, in which:

FIG. 1 is a block diagram of a video processing apparatus according to an exemplary embodiment of the present invention;

FIG. 2 is a detailed block diagram of a noise measuring unit of a video processing apparatus according to an exemplary embodiment of the present invention;

FIG. 3 illustrates regions in which a noise measuring unit measures noise from a waveform of a composite video signal according to an exemplary embodiment of the present invention;

FIG. 4 is a graphical representation of a noise gain output from a noise gain control unit of a video processing apparatus according to an exemplary embodiment of the present invention;

FIG. 5 is a detailed block diagram of a mixer of a video processing apparatus according to an exemplary embodiment of the present invention; and

FIG. 6 is a flowchart provided to explain a video processing method of a video processing apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

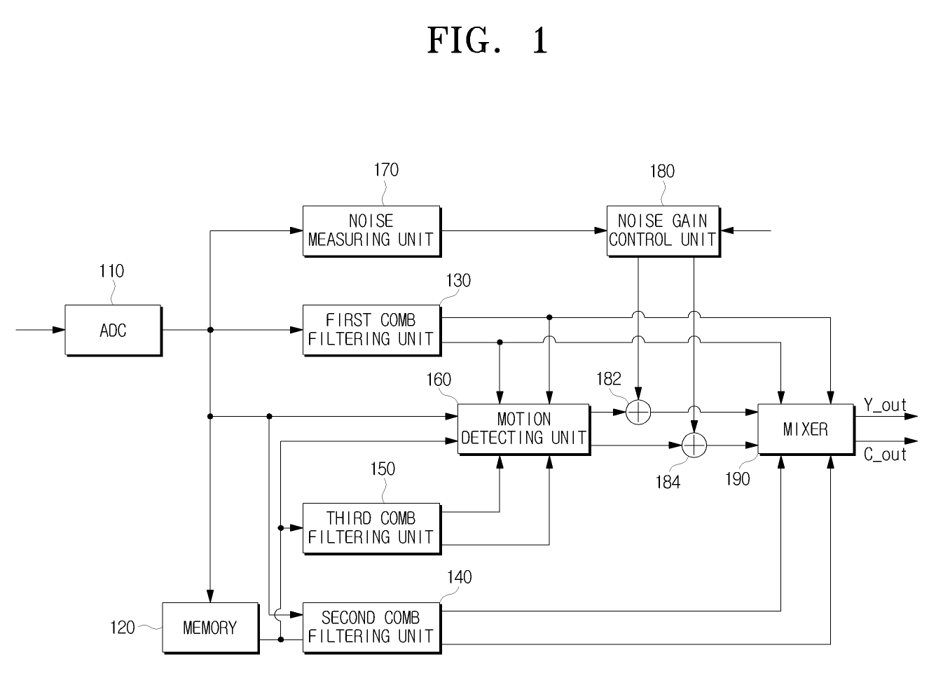

FIG. 1 is a block diagram of a light source driving apparatus according to an exemplary embodiment of the present invention.

A video processing apparatus measures an amount of noise contained in an incoming composite video signal, separates luminance and chroma signals using 2D comb filtering and 3D comb filtering in different proportions depending on the measured amount of noise, and outputs the luminance and chroma signals.

Referring to FIG. 1, the video processing apparatus according to an exemplary embodiment of the present invention may include an analog-to-digital converter (ADC) 110, a memory 120, a first comb filtering unit 130, a second comb filtering unit 140, a third comb filtering unit 150, a motion detecting unit 160, a noise measuring unit 170, a noise gain control unit 180, a first adder 182, a second adder 184, and a mixer 190.

The ADC 110 converts an incoming frame-wise analog composite video signal into a digital form. The memory 120 stores the frame-wise digital composite video signals in input order.

The first comb filtering unit 130 separates a currently incoming frame-wise composite video signal into a luminance signal and a chroma signal using a line delay. The second comb filtering unit 140 separates luminance and chroma signals with respect to the currently incoming frame-wise composite video signal and previously input frame-wise composite video signal stored in the memory 120, using frame delay.

The third comb filtering unit 150 separates a previously input frame-wise composite video signal stored in the memory 120 into luminance and chroma signals using line delay. The first and the third comb filtering units 130, 150 may implement 2D comb filters.

The motion detecting unit 160 detects motion from the currently incoming composite video signal. Specifically, the motion detecting unit 160 outputs a luminance motion signal that indicates the degree of motion corresponding to the luminance component of each pixel, using a currently incoming frame-wise composite video signal, a previously-input frame-wise composite video signal stored in the memory 120, a luminance signal separated by the first comb filtering unit 130, and a luminance signal separated by the third comb filtering unit 150.

The motion detecting unit 160 also outputs a chroma motion signal that indicates the degree of motions with respect to chroma components of each pixel, using a currently incoming frame-wise composite video signal, a previously-input frame-wise composite video signal stored in the memory 120, a chroma signal separated by the first comb filtering unit 130, and a chroma signal separated by the third comb filtering unit 150.

The noise measuring unit 170 measures the amount of noise contained in a currently incoming composite video signal, and outputs a noise level that corresponds to the measured amount of noise. The noise gain control unit 180 outputs noise gains that correspond to luminance and chroma signals, respectively, based on user set values with respect to the noise levels output by the noise measuring unit 170.

The first adder 182 adds the noise gain of the luminance signal output from the noise gain control unit 180 to the luminance motion signal output from the motion detecting unit 160, and outputs the resultant signal. The second adder 184 adds the noise gain of the chroma signal output from the noise gain control unit 180 to the chroma motion signal output from the motion detecting unit 160, and outputs the resultant signal.

The mixer 190 mixes the luminance signal separated by the first comb filtering unit 130, the luminance signal separated by the second comb filtering unit 140, and the luminance motion signal including the noise gain output from the first adder 182 to output a luminance signal (Y_out).

The mixer 190 also mixes the chroma signal separated by the first comb filtering unit 130, the chroma signal separated by the second comb filtering unit 140, and the chroma motion signal including the noise gain output from the first adder 182 to output a chroma signal (C_out).

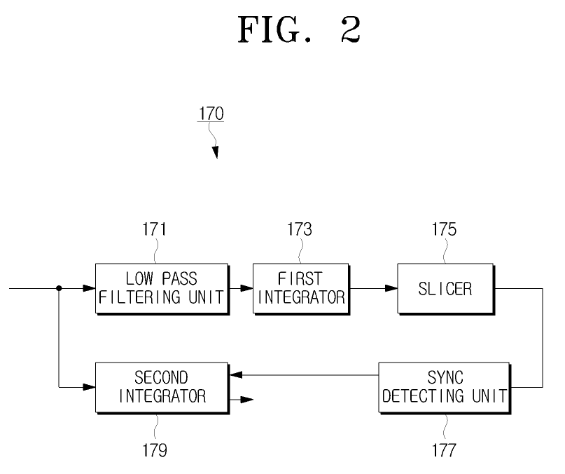

FIG. 2 is a detailed block diagram of a noise measuring unit of a video processing apparatus according to an exemplary embodiment of the present invention.

Referring to FIG. 2, the noise measuring unit 170 may include a low pass filtering unit 171, a first integrator 173, a slicer 175, a sync detecting unit 177, and a second integrator 179.

The low pass filtering unit 171 filters an incoming composite video signal with respect to 1 MHz to remove the chroma signal, considering the fact that a chroma signal is generally present in a 3.58 MHz band.

The first integrator 173 performs integration of luminance signals which are removed by the low pass filtering unit 171. The slicer 175 slices the resultant luminance signals from the integration into predetermined slice levels. By doing so, a sync region, which does not have either a chroma signal or a luminance signal, is detected. The slice level to detect the sync region is set to below 300 mV, because the sync region has a level of 300 mV.

The sync detecting unit 177 detects a sync region in the signal sliced by the slicer 175, and outputs a sync region signal containing information about the detected sync region. The second integrator 179 performs integration of the sync region of an incoming composite video signal, based on the sync region signal being output from the sync detecting unit 177, and outputs the result of integration as a noise level.

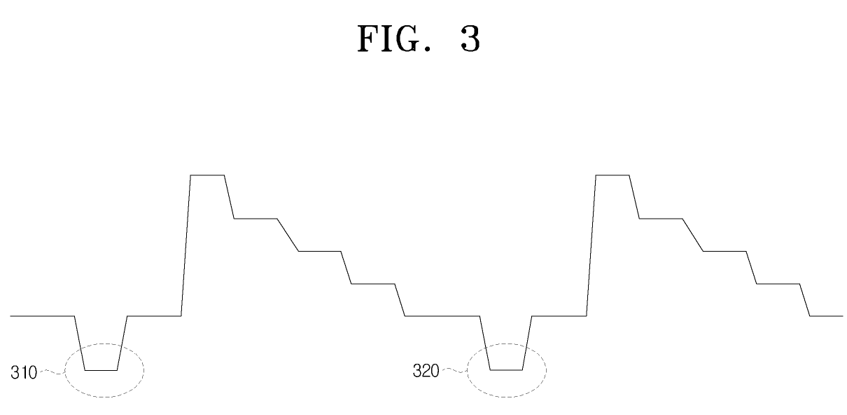

FIG. 3 illustrates regions in which a noise measuring unit measures noise from a waveform of a composite video signal according to an exemplary embodiment of the present invention.

Referring to FIG. 3, the signal waveform illustrated indicates that the chroma signal is removed from the composite video signal by the low pass filtering unit 171, that the waveform represents resultant luminance signal after the integration by the first integrator 173, and that the composite video signal includes sync regions 310, 320 to measure noise.

The sync regions 310, 320 repeat periodically for synchronization purposes, and do not contain a luminance signal or a chroma signal therein. Because the sync regions 310, 320 do not contain luminance or chroma signals therein, an exact amount of noise included in the composite video signal can be measured from the sync regions 310, 320 if noise is present.

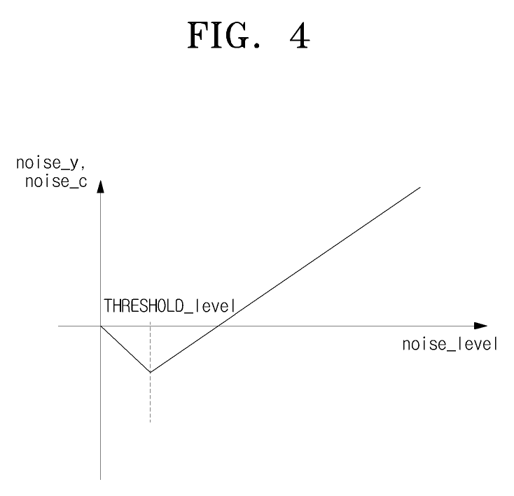

FIG. 4 is a graphical representation of a noise gain output from a noise gain control unit of a video processing apparatus according to an exemplary embodiment of the present invention.

FIG. 4 illustrates the relationship between a luminance signal output according to noise level (noise_level) on one hand, and noise gain (noise_y, noise_c) according to a chroma signal on the other hand. Specifically, noise gain corresponding to luminance and chroma signals is negative, if the noise level is less than a threshold level (threshold_level), and noise gain corresponding to luminance and chroma signals is positive, if the noise level exceeds the threshold level (threshold_level).

The factors to determine noise level include threshold level, luminance gain to determine a slope of noise gain, and chroma gain. Such factors as threshold level, luminance gain and chroma gain may be set in advance to ideal values, or set by a user.

That is, the noise gain control unit 180 may output noise gains of luminance and chroma signals according to noise levels, respectively, based on the threshold level, the luminance gain and the chroma gain.

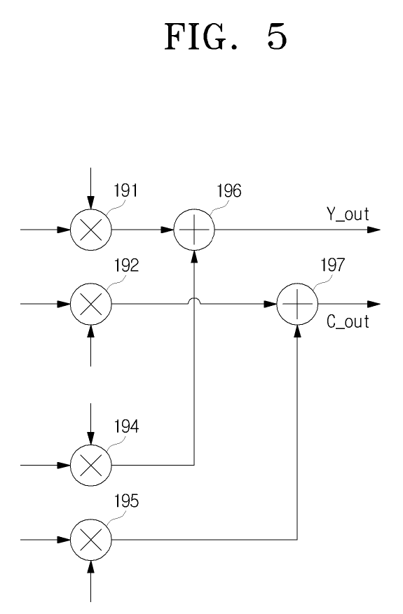

FIG. 5 is a detailed block diagram of a mixer of a video processing apparatus according to an exemplary embodiment of the present invention.

Referring to FIG. 5, the mixer 190 includes first to fourth multipliers 191, 192, 194, 195, and third and fourth adders 196, 197.

The first multiplier 191 multiplies a luminance signal separated by the first comb filtering unit 130 by a luminance motion signal added with a noise gain output from the first adder 182, and outputs the result.

The second multiplier 192 multiplies a chroma signal separated by the first comb filtering unit 130 by a chroma motion signal added with a noise gain output from the second adder 184, and outputs the result.

The third multiplier 194 multiplies a luminance signal separated by the second comb filtering unit 140 by a signal obtained by subtracting from 1 a luminance motion signal added with a noise gain output from the first adder 182, and outputs the result.

The fourth multiplier 195 multiplies a chroma signal separated by the second comb filtering unit 140 by a signal obtained by subtracting from 1 a chroma motion signal added with a noise gain output from the second adder 184.

The third adder 196 adds an output signal from the first multiplier 191 to an output signal from the third multiplier 194, and outputs a luminance signal (Y_out). The fourth adder 197 adds an output signal from the second multiplier 192 to an output signal from the fourth multiplier 195, and outputs a chroma signal (C_out).

The luminance signal (Y_out) and chroma signal (C_out) may be computed by:

Y_out=((M_{—}y+noise_{—}y)*Y_{—}2d)+((1−(M_{—}y+noise_{—}y))*Y_temp)C_out=((M_{—}c+noise_{—}c)*C_{—}2d)+((1−(M_{—}c+noise_{—}c))*C_temp)| [Mathematical formula 1]

In Mathematical formula 1, M_y denotes a luminance motion signal output from the motion detecting unit 160, and noise_y denotes a noise gain corresponding to a luminance signal output from the noise gain control unit 180. Accordingly, (M_y+noise_y) represents a luminance motion signal added with a noise gain output from the first adder 182.

Also in Mathematical formula 1, Y_2d denotes a luminance signal separated by the first comb filtering unit 130, and ((M_y+noise_y)* Y_2d) is a signal output from the first multiplier 191.

The term M_c denotes a chroma motion signal output from the motion detecting unit 160, and noise_c is a noise gain of a chroma signal output from the noise gain control unit 180. Accordingly, (M_c+noise_c) is a chroma motion signal added with a noise gain output from the second adder 184.

The term C_2d denotes a chroma signal separated by the first comb filtering unit 130, and ((M_c+noise_c)* C_2d) is a signal output from the second multiplier 192.

The term C_temp denotes a chroma signal separated by the second comb filtering unit 140, and ((1−(M_c+noise_c))*C_temp) is a signal output from the fourth multiplier 197.

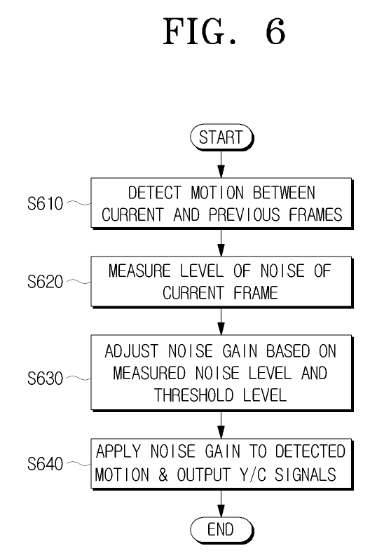

FIG. 6 is a flowchart provided to explain a video processing method of a video processing apparatus according to an exemplary embodiment of the present invention.

Referring to FIG. 6, at operation S610, the motion detecting unit 160 detects motion between current and previous frames.

At operation S620, the noise measuring unit 170 measures the noise level of the current frame.

At operation S630, the noise gain control unit 180 outputs a noise gain according to the noise level which is measured by the noise measuring unit 170 based on a noise gain determining value.

At operation S640, the mixer 190 outputs luminance and chroma signals by applying a noise gain output from the noise gain control unit 180 to a motion detected by the motion detecting unit 160. Specifically, as noise gain is applied to motion, the motion decreases due to a negative noise gain, if a noise level is below a threshold level. As a result, a 2D comb filtered signal decreases, and a 3D comb filtered signal increases.

In other words, a 3D comb filtered signal is increased if the amount of noise is relatively small in the composite video signal, to improve artifacts that would have occurred due to 2D comb filtering.

Conversely, motion increases due to a positive noise gain, if the noise level exceeds the threshold level. As a result, 2D comb filtered signal increases, while 3D comb filtered signal decreases.

As the 2D comb filtered signal increases if the amount noise is relatively great in the composite video signal, artifacts due to 3D comb filtering is improved.

While an incoming video signal is separated into a luminance signal and a chroma signal in the above exemplary embodiments of the present invention, one skilled in the art would appreciate that this is only for the purpose of example and that an incoming signal can be separated into other types of signals beside the luminance and chroma signals.

Furthermore, while a comb filter is used to separate an incoming video signal into luminance and chroma signals in the above exemplary embodiments of the present invention, one skilled in the art would appreciate that other types of filters may well be used to separate the video signal.

As explained above in the exemplary embodiments of the present invention, video artifacts are prevented, because 2D comb filtering is selectively used for an incoming composite video signal, according to whether the video signal includes noise or not.

Furthermore, video quality is enhanced, by measuring the amount of noise included in an incoming composite video signal, and adaptively separating luminance and chroma signals according to the measured amount of noise.

Furthermore, video artifacts due to use of 2D or 3D comb filtering are compensated and enhanced, by adaptively determining the proportion between 2D and 3D comb filtered signals according to the measured amount of noise.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A video processing method, comprising:
separating an incoming video signal into a luminance signal and a chroma signal using a first filtering and a second filtering;
measuring a level of noise contained in the incoming video signal; and
based on the measured level of noise, mixing luminance signals separated by the first and second filtering and outputting the result, and mixing chroma signals separated by the first and second filtering and outputting the result.

2. The video processing method of claim 1, wherein the outputting comprises outputting the luminance signal separated by the first filtering and the luminance signal separated by the second filtering in different proportions according to the measured level of noise, and outputting the chroma signal separated by the first filtering and the chroma signal separated by the second filtering in different proportions according to the measured level of noise.

3. The video processing method of claim 1, wherein the measuring comprises:
removing the chroma signal by low pass filtering the incoming video signal;
performing integration of the luminance signal from which the chroma signal is removed to produce a first integration result;
slicing the resultant luminance signal from the first integration result based on a predetermined slice level;
detecting a sync region in the sliced luminance signal, and outputting a sync region signal that includes information about the detected sync region; and
performing integration of the sync region of the incoming video signal based on the output sync region signal to produce a second integration result and outputting the second integration result as a noise level.

4. The video processing method of claim 1, wherein the outputting comprises outputting a noise gain corresponding to the luminance signal and the chroma signal according to the measured level of noise, and the noise gain is output according to the measured level of noise based on a noise gain determining value.

5. The video processing method of claim 4, wherein the noise gain determining value comprises a threshold level as a reference to be compared with the measured level of noise, and a luminance gain and a chroma gain which determine a slope of the noise gain.

6. The video processing method of claim 4, wherein the outputting the noise gain comprises outputting a negative noise gain corresponding to the luminance signal and the chroma signal if the measured level of noise is below the threshold level, and outputting a positive noise gain corresponding to the luminance signal and the chroma signal if the measured level of noise exceeds the threshold level.

7. The video processing method of claim 4, wherein the outputting further comprises comparing the incoming video signal with a previously input video signal, and detecting a luminance motion signal that indicates the degree of motion of a luminance component, and a chroma motion signal that indicates the degree of motion of a chroma component of the incoming video signal.

8. The video processing method of claim 7, wherein the outputting further comprises:
adding a noise gain corresponding to the luminance signal to the detected luminance motion signal; and
adding a noise gain corresponding to the chroma signal to the detected chroma motion signal.

9. The video processing method of claim 1, wherein the first filtering is a 2D comb filtering, and the second filtering is a 3D comb filtering.

10. The video processing method of claim 1, wherein the incoming video signal is a composite video signal.

11. A video processing apparatus, comprising:
a first filtering unit which separates an incoming video signal into a luminance signal and a chroma signal using a first filtering and a second filtering;
a second filtering unit which separates the luminance signal and the chroma signal with respect to the incoming video signal; a noise measuring unit which measures a level of noise contained in the incoming video signal; and
a mixer which mixes the luminance signals separated by the first and second filtering and outputs the result, and mixes the chroma signals separated by the first and second filtering and outputs the result, based on the measured level of noise.

12. The video processing apparatus of claim 11, wherein the mixer outputs the luminance signal separated by the first filtering and the luminance signal separated by the second filtering in different proportions according to the measured level of noise, and outputs the chroma signal separated by the first filtering and the chroma signal separated by the second filtering in different proportions according to the measured level of noise.

13. The video processing apparatus of claim 11, wherein the noise measuring unit comprises:
a low pass filtering unit which removes the chroma signal by low pass filtering the incoming video signal;
a first integrator which performs integration of the luminance signal from which the chroma signal is removed and outputs a first integration result;
a slicer which slices the resultant luminance signal from the first integration result based on a predetermined slice level;
a sync detecting unit which detects a sync region in the sliced luminance signal, and outputs a sync region signal that includes information about the detected sync region; and
a second integrator which performs integration of the sync region of the incoming video signal based on the output sync region signal and outputs a second integration result as a noise level.

14. The video processing apparatus of claim 11, further comprising a noise gain control unit which outputs a noise gain corresponding to the luminance signal and the chroma signal according to the measured level of noise, in which the noise gain control unit outputs the noise gain according to the measured level of noise based on a noise gain determining value.

15. The video processing apparatus of claim 14, wherein the noise gain determining value comprises a threshold level as a reference to be compared with the measured level of noise, and a luminance gain and a chroma gain which determine a slope of the noise gain.

16. The video processing apparatus of claim 15, wherein the noise gain control unit outputs a negative noise gain corresponding to the luminance signal and the chroma signal if the measured level of noise is below the threshold level, and outputs a positive noise gain corresponding to the luminance signal and the chroma signal if the measured level of noise exceeds the threshold level.

17. The video processing apparatus of claim 11, further comprising a motion detecting unit which compares the incoming video signal with a previously input video signal, and detects a luminance motion signal that indicates the degree of motion of a luminance component, and a chroma motion signal that indicates the degree of motion of a chroma component of the incoming video signal.

18. The video processing apparatus of claim 17, further comprising:
a first adder which adds a noise gain corresponding to the luminance signal to the detected luminance motion signal; and
a second adder which adds a noise gain corresponding to the chroma signal to the detected chroma motion signal.

19. The video processing apparatus of claim 11, wherein the first filtering is a 2D comb filtering, and the second filtering is a 3D comb filtering.

20. The video processing apparatus of claim 12, wherein the incoming video signal is a composite video signal.

21. A video processing method, comprising:
separating an incoming video signal into a first and second signals using a first filtering and a second filtering respectively;
measuring a level of noise contained in the incoming video signal;
based on the measured level of noise, mixing the first signals separated by the first and second filtering and outputting the result, and mixing the second signals separated by the first and second filtering and outputting the result.

22. A video processing apparatus, comprising:
a first filtering unit which separates an incoming video signal into a first signal and a second signal;
a second filtering unit which separates the first signal and the second signal with respect to the incoming video signal;
a noise measuring unit which measures a level of noise contained in the incoming video signal; and
a mixer which mixes the first signals separated by the first and second filtering and outputs the result, and mixes the second signals separated by the first and second filtering and outputs the result, based on the measured level of noise.
